(19) United States
(12) Patent Application Publication
(10) Pub. No.: US 2025/0390814 A1
(43) Pub. Date: Dec. 25, 2025

(54) METHOD OF CREATING WORK PLAN, WORK PLAN CREATION DEVICE, AND NON-TRANSITORY COMPUTER-READABLE STORAGE MEDIUM STORING COMPUTER PROGRAM

(71) Applicant: SEIKO EPSON CORPORATION, Tokyo (JP)

(72) Inventor: Ayahiro NAKAJIMA, MATSUMOTO-SHI (JP)

(21) Appl. No.: 19/248,511

(22) Filed: Jun. 25, 2025

(30) Foreign Application Priority Data
Jun. 25, 2024 (JP) 2024-101637

(51) Int. Cl. G06Q 10/0631; G06Q 10/04

(52) U.S. Cl. CPC G06Q 10/06312; G06Q 10/04

(57) ABSTRACT

A method of the present disclosure includes (a) setting a processing condition including a job list that defines set-up work times in a plurality of machines for each of a plurality of jobs, (b) obtaining a temporary solution for a work plan by dividing each of the set-up work times in the job list by a time divisor to create a simplified job list and solving a job shop scheduling problem relating to the simplified job list as a 0-1 integer programming problem, and (c) modifying work times of respective jobs in the temporary solution of the set-up work times and obtaining a final solution of the work plan.

The present application is based on, and claims priority from JP Application Serial Number 2024-101637, filed Jun. 25, 2024, the disclosure of which is hereby incorporated by reference herein in its entirety.

### BACKGROUND

### 1. Technical Field

The present disclosure relates to a method of creating a work plan, a work plan creation device, and a non-transitory computer-readable storage medium storing a computer program.

### 2. Related Art

An optimization problem of a work plan in which a plurality of tasks are distributed to and executed by a plurality of machines is called a job shop scheduling problem. The job shop scheduling problem is a problem that involves determining which jobs are to be processed, in what order, and using which machines in order to achieve the most efficient allocation of the plurality of jobs. However, depending on a working condition, finding an optimal solution of the job shop scheduling problem may require an exponentially increasing computation time, and it may be impossible to solve the problem within a practical timeframe.

As a method of creating a plant operation plan, JP-A-2015-62102 discloses a method of dividing an original problem into a plurality of subproblems by time segmentation, obtaining a plurality of solutions, and combining the plurality of solutions to derive an overall approximate solution.

However, the related art described above cannot be applied to a problem in which the order of jobs can be rearranged similarly to the job shop scheduling problem. In view of this, there has been desired a technique that can solve a job shop scheduling problem without requiring an excessive computation time.

### SUMMARY

According to a first aspect of the present disclosure, there is provided a method of creating a work plan in which a plurality of jobs are distributed to and executed by a plurality of machines. The method includes (a) setting a processing condition including a job list that defines set-up work times in the plurality of machines for each of the plurality of jobs, (b) obtaining a temporary solution for the work plan by dividing each of the set-up work times in the job list by a time divisor to create a simplified job list and solving a job shop scheduling problem relating to the simplified job list as a 0-1 integer programming problem, and (c) modifying work times of respective jobs in the temporary solution of the set-up work times and obtaining a final solution of the work plan.

According to a second aspect of the present disclosure, there is provided a work plan creation device configured to create a work plan in which a plurality of jobs are distributed to and executed by a plurality of machines. The work plan creation device includes a processing condition setting unit configured to set a processing condition including a job list that defines set-up work times in the plurality of machines for each of the plurality of jobs, and a computation unit configured to obtain a temporary solution for the work plan by dividing each of the set-up work times in the job list by a time divisor to create a simplified job list and solving a job shop scheduling problem relating to the simplified job list as a 0-1 integer programming problem. The computation unit modifies work times of respective jobs in the temporary solution of the set-up work times and obtains a final solution of the work plan.

According to a third aspect of the present disclosure, there is provided a non-transitory computer-readable storage medium storing a computer program for causing a processor to execute processing of creating a work plan in which a plurality of jobs are distributed to and executed by a plurality of machines. The computer program causes the processor to execute processing of (a) setting a processing condition including a job list that defines set-up work times in the plurality of machines for each of the plurality of jobs, (b) obtaining a temporary solution for the work plan by dividing each of the set-up work times in the job list by a time divisor to create a simplified job list and solving a job shop scheduling problem relating to the simplified job list as a 0-1 integer programming problem, and (c) modifying work times of respective jobs in the temporary solution of the set-up work times and obtaining a final solution of the work plan.

### BRIEF DESCRIPTION OF THE DRAWINGS

FIG. 1 is a block diagram of a work plan creation device of an embodiment.

FIG. 2 is an explanatory diagram illustrating an example of a job list, a constraint condition, and an optimal solution of a work plan.

FIG. 3 is an explanatory diagram illustrating an example of a simplified job list.

FIG. 4 is an explanatory diagram illustrating an example of a temporary solution and a final solution of a work plane.

FIG. 5 is an explanatory diagram illustrating another method of obtaining a final solution from a temporary solution.

FIG. 6 is an explanatory diagram illustrating another example in which a final solution is obtained from a job list and a constraint condition.

FIG. 7 is a flowchart illustrating a procedure of work plan creation processing of a first embodiment.

FIG. 8 is a flowchart illustrating a procedure of work plan creation processing of a second embodiment.

FIG. 9 is a flowchart illustrating a processing procedure of step S100.

### DESCRIPTION OF EMBODIMENTS

### A. First Embodiment

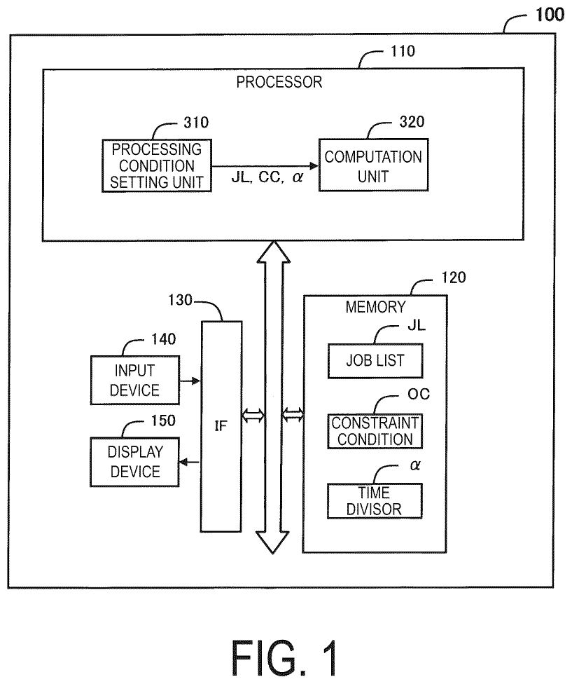

FIG. 1 is a block diagram illustrating functions of a work plan creation device 100 of an embodiment. The work plan creation device 100 includes a processor 110, a memory 120, an interface circuit 130, and an input device 140 and a display device 150 that are coupled to the interface circuit 130. Not limited thereto, the processor 110 not only has a function of performing processing described in detail below, but also has a function of displaying data obtained by the processing and data generated in a process of the processing on the display device 150. The work plan creation device 100 can be achieved by a computer such as a personal computer.

The processor 110 achieves functions of a processing condition setting unit 310 and a computation unit 320. The processing condition setting unit 310 sets a processing condition of the work plan, and the computation unit 320 obtains a final solution of the work plan by solving a job shop scheduling problem as a 0-1 integer programming problem. The processing condition that is set by the processing condition setting unit 310 includes a job list JL, a constraint condition CC, and a time divisor α. Those contents in the processing condition are described later. The functions of these units are achieved by the processor 110 executing a computer program stored in the memory 120. However, the functions of these units may be achieved by a hardware circuit. The processor in this specification is a term including such a hardware circuit.

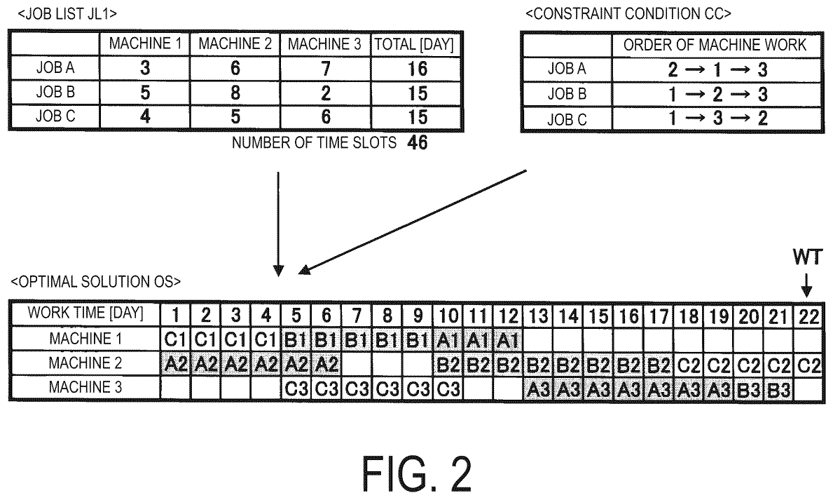

FIG. 2 is an explanatory diagram illustrating an example of the job list JL, a constraint condition CC, and an optimal solution OS of the work plan. The job list JL is a list that defines set-up work times in a plurality of machines for each of a plurality of jobs. FIG. 2 illustrates an example of a job list JL1 when a job A to a job C are executed by a machine 1 to a machine 3. For example, for the job A, the set-up work time of the operation in the machine 1 is set to three days, the set-up work time of the operation in the machine 2 is set to six days, and the set-up work time of the operation in the machine 3 is set to seven days. The total of the set-up work times of the job A to the job C is referred to as the “number of time slots”. In the example of FIG. 2, the number of time slots is 46. The unit of the work time is not limited to a “day”, and may be other units such as “minute” and “hour”. It is assumed that the plurality of jobs cannot be executed simultaneously by the same machine.

In the present disclosure, the “job” indicates one job that is completed by processing by the plurality of machines, and the “operation” indicates processing for executing one job by one machine. Therefore, one job is completed by a plurality of operations.

The constraint condition CC defines which machine is used to execute each job and in what order. For example, it is defined that the job A is first processed by the machine 2, is processed by the machine 1, and is finally processed by the machine 3. However, other constraint conditions may be set.

The optimal solution OS illustrated in FIG. 2 is an example of an optimal solution that is obtained by solving a job shop scheduling problem relating to the job list JL1 as a 0-1 integer programming problem under the constraint condition CC. Two reference symbols are written in each time slot, and the first reference symbol represents a job name, and the second reference symbol represents a machine name. For example, on the first day, the machine 1 executes the job C, the machine 2 executes the job A, and the machine 3 does not execute a job. A work period WT of the optimal solution OS is 22 days. The “work period WT” indicates a period required for completing all of the plurality of works. In the embodiment, in a solution process, for a 0-1 integer programming problem, optimization processing is executed so as to minimize the work period WT. An objective function of the optimization processing may be the work period WT. Alternatively, a value other than the work period WT may be the objective function. In the latter case, the objective function may be set in such a way that, by maximizing or minimizing the objective function, the work period WT is ultimately minimized.

In general, when a job shop scheduling problem is formulated as a 0-1 integer programming problem, binary variables are prepared in proportion to the number of time slots, and an optimal solution that satisfies the constraint condition CC is obtained. As described above, the number of time slots is the total of the work times. When the number of time slots is increased, the number of binary variables is increased, and a computation time is increased. In view of this, in order to speed up the solution process, it is effective to simplify the job list JL so that the number of time slots is reduced.

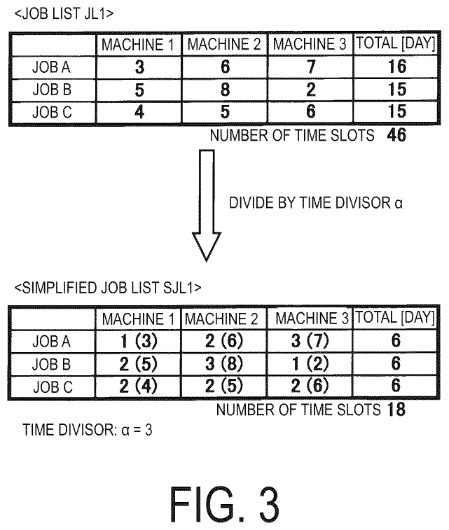

FIG. 3 is an explanatory diagram illustrating an example of a simplified job list SJL1 of the embodiment. The simplified job list SJL1 is obtained by dividing the set-up work times of the respective operations in the original job list JL1 by the time divisor α. The number in parentheses in the simplified job list SJL1 represents the original set-up work time. The time divisor α can be set to a freely selected value greater than 1. In the example of FIG. 2, α=3 is given, and the decimal portion of the division result obtained by dividing the original set-up work time by the time divisor α is rounded up. However, instead of rounding up, other rounding operations such as rounding to the nearest integer or rounding down may also be used. The number of time slots in the simplified job list SJL1 is 18, and is less than the number of time slots in the original job list JL1. Thus, a computation time can be reduced.

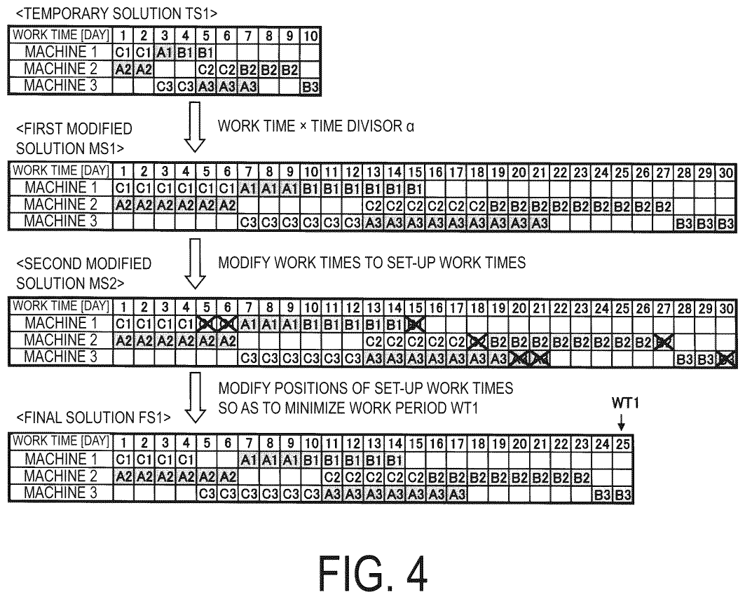

FIG. 4 is an explanatory diagram illustrating an example of a temporary solution TS1 and a final solution FS1 of the work plan. The temporary solution TS1 is an optimal solution obtained by solving a 0-1 integer programming problem by using the simplified job list SJL1 illustrated in FIG. 3. In the processing in FIG. 4, first, a first modified solution MS1 is created by multiplying the work time of each time slot in the temporary solution TS1 by the time divisor α. In this state, a blank time slot is also multiplied by the time divisor α, and is increased by a factor of x. The blank time slot is also simply referred to as a “blank time”. In the example of FIG. 4, the time divisor α is 3. Next, the work times of the respective operations in the first modified solution MS1 are modified to the set-up work times in the job list JL1. With this, a second modified solution MS2 is obtained. A time slot with the mark “x” in the second modified solution MS2 is a time removed during modification to the set-up work time.

The second modified solution MS2 may contain a blank time between operations of each job. For example, the operation of job C by the machine 3 is started on the seventh day, but it can be started on the fifth day. Therefore, there are blank times for two days. In view of this, modification where the set-up work times in the second modified solution MS2 are shifted forward or backward is performed so as to minimize a work period WT1 while satisfying the constraint condition CC. With this, the final solution FS1 is created. For example, the set-up work time for the job C by the machine 3 is shifted to the left by two days. As a result, the final solution FS1 with the minimized work period WT1 is obtained while satisfying the constraint condition CC.

The work period WT1 of the final solution FS1 is slightly longer than the work period WT of the optimal solution OS illustrated in FIG. 2. Thus, the final solution FS1 is an approximate solution. However, when the simplified job list SJL1 is used, the final solution FS1 can be obtained within a computation time shorter than that in a case in which the original job list JL is used.

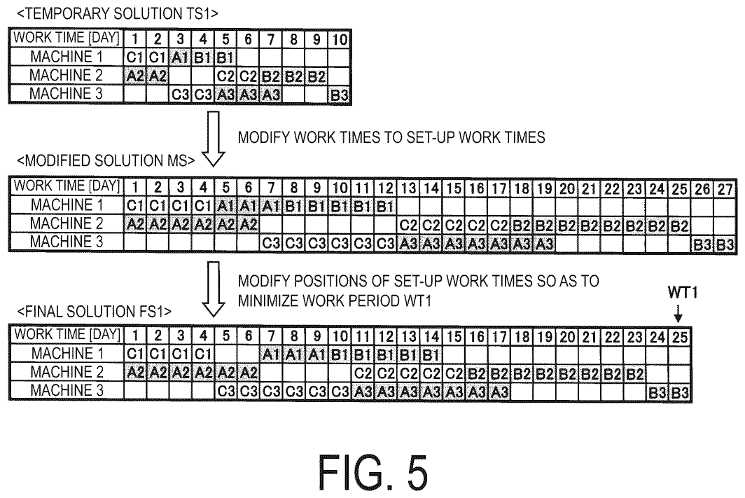

FIG. 5 is an explanatory diagram illustrating another method of obtaining the final solution FS1 from the temporary solution TS1. The contents of the temporary solution TS1 and the final solution FS1 are the same as those in FIG. 4, and the method of obtaining the final solution FS1 from the temporary solution TS1 is different from that in FIG. 4. In the method in FIG. 5, first, the respective work times in the temporary solution TS1 are modified to the set-up work times in the job list JL1. With this, the modified solution MS is obtained. In this state, a blank time slot is also multiplied by the time divisor α, and is increased by a factor of x. Next, modification where the set-up work times in the modified solution MS are shifted forward or backward is performed so as to minimize a work period WT1 while satisfying the constraint condition CC. With this, the final solution FS1 is created.

Note that the examples in FIG. 4 and FIG. 5 are similar in that the modified solution is obtained by modifying the work times in the temporary solution TS1 to the original set-up work times and the final solution FS1 is obtained by shifting the set-up work times in the modified solution so as to minimize the work period WT1 while satisfying the constraint condition CC. Note that, in the example in FIG. 4, when the final solution FS1 is obtained from the second modified solution MS2, the set-up work time may be shifted forward to left-align the set-up work time. In contrast, in the example in FIG. 5, the set-up work time in the modified solution MS may be shifted backward in order to satisfy the constraint condition CC. In view of this point, the method in FIG. 4 is preferable because it is simpler than the method in FIG. 5.

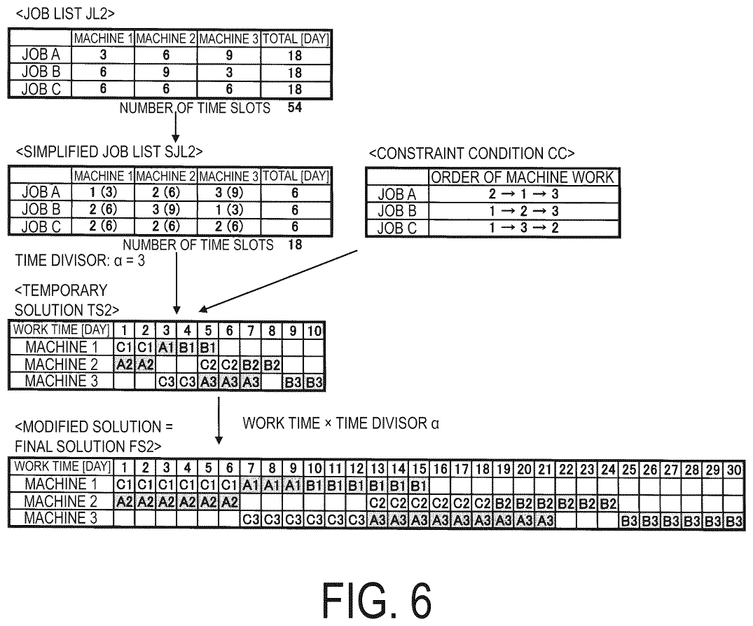

FIG. 6 is an explanatory diagram illustrating another example in which the final solution FS is obtained from the job list JL and the constraint condition CC. A job list JL2 in FIG. 6 is different from the job list JL1 illustrated in FIG. 2 in that the set-up work time for each job by each machine is a multiple of 3. A simplified job list SJL2 is obtained by dividing the set-up work times in the job list JL2 by the time divisor α. The time divisor α is 3, and is the greatest common divisor of all the set-up work times in the job list JL2. A temporary solution TS2 is an optimal solution obtained by solving a 0-1 integer programming problem by using the simplified job list SJL2 and the constraint condition CC. The constraint condition CC is the same as that illustrated in FIG. 2.

In the example of FIG. 6, a modified solution is created by multiplying the work times and the blank times in the temporary solution TS2 by the time divisor α, and the modified solution is adopted as a final solution FS2. The method of creating the modified solution is equivalent to the method of creating the first modified solution MS1 in FIG. 4 and the method of creating the modified solution MS in FIG. 5.

In the example in FIG. 6, the time divisor α is the greatest common divisor of all the set-up work times in the job list JL2. Thus, the simplified job list SJL2 corresponds to a list obtained by simply scaling the set-up work times in the original job list JL2 by a factor of 1/α. Therefore, the temporary solution TS2 being an optimal solution obtained by using the simplified job list SJL2 should correspond to a solution obtained by scaling the optimal solution of the job list JL2 by a factor of 1/α. Therefore, the final solution FS2 that is obtained by multiplying the work times and the blank times in the temporary solution TS2 by α is an optimal solution of the job list JL2. Further, the temporary solution TS2 is obtained to satisfy the constraint condition CC, and hence the final solution FS2 also satisfies the constraint condition CC. Therefore, there is no need to shift the set-up work time of the modified solution to the right or to the left so as to satisfy the constraint condition CC.

As in the example in FIG. 6, the time divisor α may be set to an integer greater than 1, which is the greatest common divisor of all the set-up work times in the job list JL. In this manner, the final solution FS of the work plan can be obtained without executing processing of shifting the set-up work times in the modified solution. Further, the final solution FS is preferred because the final solution FS is an optimal solution that is obtained by solving a job shop scheduling problem relating to the job list JL as a 0-1 integer programming problem.

Note that the time divisor α may not be the greatest common divisor of all the set-up work times in the job list JL, and may be a common divisor being an integer greater than 1. In such a case, it is also possible to obtain the optimal solution of the original job list JL as the final solution FS by using the simplified job list SJL obtained through simplification with the time divisor α.

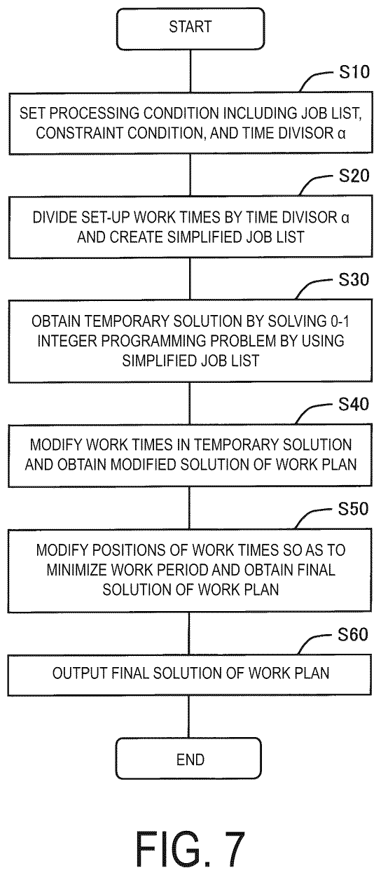

FIG. 7 is a flowchart illustrating a procedure of work plan creation processing of a first embodiment. In step S10, the processing condition setting unit 310 sets the processing condition including the job list JL, the constraint condition CC, and the time divisor α. The job list JL, the constraint condition CC, and the time divisor α may all be set according to specifications by a user. However, a part of the processing condition may be set to an initial condition that is set in advance.

In step S20, the computation unit 320 creates the simplified job list SJL by dividing the set-up work times in the job list JL by the time divisor α. In step S30, the computation unit 320 obtains the temporary solution TS by solving a 0-1 integer programming problem by using the simplified job list SJL. In step S40, the computation unit 320 modifies the work time in the temporary solution TS, and obtains the modified solution MS of the work plan. In step S50, the positions of the work times in the modified solution MS are modified so as to minimize the work period while satisfying the constraint condition CC. With this, the final solution FS of the work plan is obtained. Steps S40 and S50 are executed by the method in FIG. 4 to FIG. 6 described above. However, as described in FIG. 6, the modified solution MS is an optimal solution of the original job list JL, step S50 can be omitted, and the modified solution MS obtained in step S40 is adopted as the final solution FS.

In step S60, the final solution FS of the work plan is output. For example, the output of the final solution FS is performed by displaying the final solution FS by the display device 150. Alternatively, the final solution FS may be output to an external device. In this state, a user may be notified while explicitly stating whether the final solution FS of the work plan is an optimal solution or an approximate solution. In this case, when the time divisor α is a common divisor of all the set-up work times in the job list JL, it is explicitly stated that the final solution FS is an optimal solution. In contrast, when the time divisor α is not a common divisor of all the set-up work times in the job list JL, it is explicitly stated that the final solution FS is an approximate solution. With this, a user can understand whether the final solution FS of the work plan being output is an optimal solution or an approximate solution.

As described above, in the first embodiment, the simplified job list SJL is created by dividing the set-up work times in the job list JL by the time divisor α, and a job shop scheduling problem thereof is solved as a 0-1 integer programming problem. Thus, a computation time can be reduced, and the final solution of the work plan can be created within a short amount of time.

### B. Second Embodiment

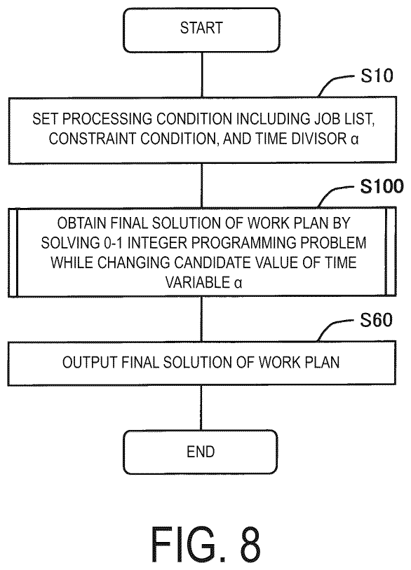

FIG. 8 is a flowchart illustrating a procedure of work plan creation processing of a second embodiment. The device of the second embodiment is the same as the device of the first embodiment. The processing procedure of the second embodiment is obtained by replacing steps S20 to S50 in the processing procedure of the first embodiment illustrated in FIG. 7 with step S100, and the other steps are the same as those in FIG. 7. In step S100, the computation unit 320 solves a 0-1 integer programming problem while changing a candidate value of the time divisor α. With this, the processing of obtaining the final solution FS of the work plan is executed.

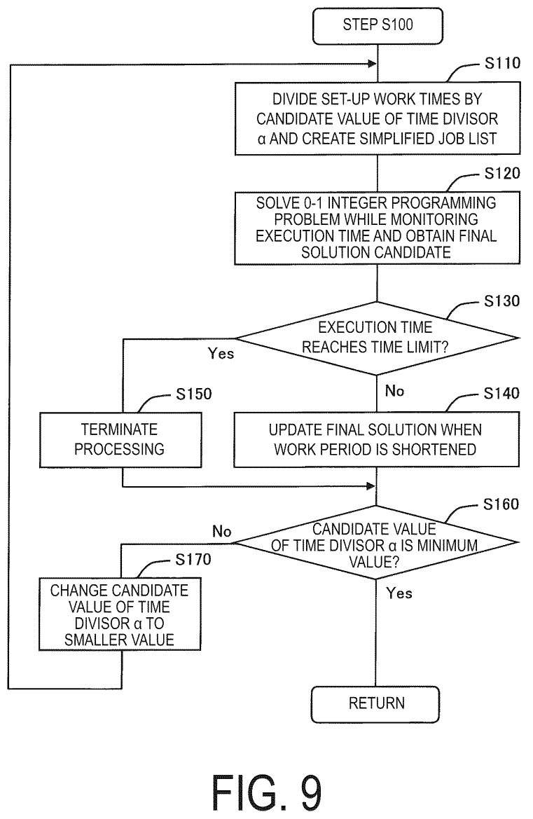

FIG. 9 is a flowchart illustrating a processing procedure of step S100. In step S110, the computation unit 320 creates the simplified job list SJL by dividing the set-up work times in the job list JL by the candidates value of the time divisor α. The candidate value of the time divisor α, which is used when step S110 is executed for the first time, is a value of the time divisor α that is set in step S10 in FIG. 8.

In step S120, the computation unit 320 executes the solution process of a 0-1 integer programming problem while monitoring an execution time, and executes processing for obtaining final solution candidates. Steps S110 and S120 correspond to a repetition step for executing steps S20 to S50 in FIG. 7 while monitoring the execution time. The term “final solution candidate” indicates the final solution FS corresponding to one candidate value of the time divisor α. As described below, in step S100, the final solution candidates are obtained while changing the candidates value of the time divisor α, and the best solution among those is adopted as the final solution FS. The execution time being a monitoring target in step S120 may be the total execution time in steps S20 to S50 in FIG. 7, the execution time in steps S20 to S30, or the execution tie in step S30.

In step S130, it is determined whether the execution time being a monitoring target reaches a predetermined time limit. When the execution time being a monitoring target reaches the time limit, the execution of step S120 is terminated in step S150, and the processing proceeds to step S160. In contrast, when the processing of step S120 is completed before the execution time being a monitoring target reaches the time limit, the processing proceeds to step S140. In step S140, a work period WT of the final solution candidate, which is obtained in step S120, is shorter than the work period WT of the final solution FS, which is previously obtained, the final solution candidate is newly adopted as final solution FS, and the final solution FS is updated. Note that, when step S140 is executed for the first time, the final solution candidate obtained in step S120 is directly adopted as the final solution FS.

In step S160, it is determined whether the candidate value of the time divisor α reaches a predetermined minimum value. The minimum value of the candidate value of the time divisor α may be 1.0, or may be a value greater than 1.0. When the candidate value of the time divisor α reaches the minimum value, the processing of step S100 is terminated. In contrast, when the candidate value of the time divisor α does not reach the minimum value, the processing proceeds to step S170, and the candidate value of the time divisor α is set to a smaller value. Note that the plurality of candidate values for the time divisor α may be set in advance. After step S170, the processing returns to step S110, and the set-up work times in the original job list JL is divided by a new candidate value of the time divisor α. With this, the simplified job list SJL is updated. After that, the simplified job list SJL being updated is used to execute the processing after step S120 again.

Note that, when the execution of step S120 is terminated in step S150, the processing may not proceed to step S160, and the entire processing in step S100 may be terminated. The reason for this is that, even when step S120 using a smaller candidate value of the time divisor α is executed again after terminating the execution of step S120 in step S150, there is a high possibility that the execution time reaches the time limit. Further, in the example in FIG. 9, the candidate value of the time divisor α is gradually changed to a smaller value. However, the candidate value of the time divisor α may be gradually changed to a greater value. Moreover, the plurality of candidate values of the time divisor α that are used in step S100 may be specified in advance by a user.

The second embodiment also exerts effects similar to those of the first embodiment. Further, in the second embodiment, the repetition step for obtaining the final solution FS by changing the simplified job list SJL while gradually changing the candidate values of the time divisor α is executed, and execution thereof is terminated when the execution time reaches the time limit. Thus, an excessive computation time can be avoided.

### Other Embodiments

The present disclosure is not limited to the embodiments described above, and may be achieved in various aspects without departing from the spirits of the disclosure. For example, the present disclosure can also be achieved by the following aspects. Appropriate replacements or combinations may be made to the technical features in the above-described embodiments which correspond to the technical features in the aspects described below to solve some or all of the problems of the disclosure or to achieve some or all of the advantageous effects of the disclosure. Further, even when technical characteristics are not described as essential ones in the present specification, it is possible to delete the technical characteristics in the embodiments appropriately.
(1) According to a first aspect of the present disclosure, there is provided a method of creating a work plan in which a plurality of jobs are distributed to and executed by a plurality of machines. The method includes (a) setting a processing condition including a job list that defines set-up work times in the plurality of machines for each of the plurality of jobs, (b) obtaining a temporary solution for the work plan by dividing each of the set-up work times in the job list by a time divisor to create a simplified job list and solving a job shop scheduling problem relating to the simplified job list as a 0-1 integer programming problem, and (c) modifying work times of respective jobs in the temporary solution of the set-up work times and obtaining a final solution of the work plan.

According to the method, the job shop scheduling problem relating to the simplified job list is solved as a 0-1 integer programming problem. Thus, a computation time can be reduced, and the final solution of the work plan can be created within a short amount of time.
(2) In the method described above, the step (c) may include (c1) obtaining a modified solution by correcting the work times in the temporary solution of the set-up work times, and (c2) obtaining the final solution of the work plan by shifting the set-up work times in the modified solution so as to minimize a work period of the work plan while satisfying a constraint condition of the work plan.

According to the method, the final solution of the work plan can be obtained by simple processing.
(3) The method described above may include a repetition step for obtaining a plurality of final solution candidates corresponding to a plurality of candidate values for the time divisor by executing the steps (b) to (c) for the simplified job list while gradually changing the candidates values for the time divisor, the simplified job list being created by using the candidates values, and determining a final solution candidate with the shortest work period among the plurality of final solution candidates as the final solution. The repetition step may include terminating execution of the repetition step when an execution time of the step (b) or the repetition step reaches a predetermined time limit.

According to the method, when an execution time of the step (b) or the repetition step reaches a predetermined time limit, execution thereof is stopped. Thus, an excessive computation time can be avoided.
(4) In the method described above, the time divisor may be the greatest common divisor of all the set-up work times in the job list.

According to the method, the final solution being an optimal solution can be obtained.
(5) The method described above may further include (d) explicitly stating whether the final solution of the work plan is an optimal solution or an approximate solution and outputting the final solution.

According to the method, a user can understand whether the final solution is an optimal solution or an approximate solution.
(6) In the method described above, the step (a) may include setting a value of the time divisor as the processing condition, the value being specified by a user.

According to the method, a user can specify a desired value for the time divisor.
(7) According to a second aspect of the present disclosure, there is provided a work plan creation device configured to create a work plan in which a plurality of jobs are distributed to and executed by a plurality of machines. The work plan creation device includes a processing condition setting unit configured to set a processing condition including a job list that defines set-up work times in the plurality of machines for each of the plurality of jobs, and a computation unit configured to obtain a temporary solution for the work plan by dividing each of the set-up work times in the job list by a time divisor to create a simplified job list and solving a job shop scheduling problem relating to the simplified job list as a 0-1 integer programming problem. The computation unit modifies work times of respective jobs in the temporary solution of the set-up work times and obtains a final solution of the work plan.
(8) According to a third aspect of the present disclosure, there is provided a computer program for causing a processor to execute processing of creating a work plan in which a plurality of jobs are distributed to and executed by a plurality of machines. The computer program causes the processor to execute processing of (a) setting a processing condition including a job list that defines set-up work times in the plurality of machines for each of the plurality of jobs, (b) obtaining a temporary solution for the work plan by dividing each of the set-up work times in the job list by a time divisor to create a simplified job list and solving a job shop scheduling problem relating to the simplified job list as a 0-1 integer programming problem, and (c) modifying work times of respective jobs in the temporary solution of the set-up work times and obtaining a final solution of the work plan.

The present disclosure may also be achieved by various aspects other than the above. For example, the present disclosure can be achieved by aspects such as a work plan creation device, a computer program for achieving functions thereof, and a non-transitory storage medium storing the computer program.

What is claimed is:

1. A method of creating a work plan in which a plurality of jobs are distributed to and executed by a plurality of machines, the method comprising:
(a) setting a processing condition including a job list that defines set-up work times in the plurality of machines for each of the plurality of jobs;
(b) obtaining a temporary solution for the work plan by dividing each of the set-up work times in the job list by a time divisor to create a simplified job list and solving a job shop scheduling problem relating to the simplified job list as a 0-1 integer programming problem; and
(c) modifying work times of respective jobs in the temporary solution of the set-up work times and obtaining a final solution of the work plan.

2. A method according to claim 1, wherein
the step (c) includes:
(c1) obtaining a modified solution by correcting the work times in the temporary solution of the set-up work times; and
(c2) obtaining the final solution of the work plan by shifting the set-up work times in the modified solution so as to minimize a work period of the work plan while satisfying a constraint condition of the work plan.

3. A method according to claim 1, further comprising:
a repetition step for obtaining a plurality of final solution candidates corresponding to a plurality of candidate values for the time divisor by executing the steps (b) to (c) for the simplified job list while gradually changing the candidates values for the time divisor, the simplified job list being created by using the candidates values; and
determining a final solution candidate with the shortest work period among the plurality of final solution candidates as the final solution, wherein
the repetition step includes terminating execution of the repetition step when an execution time of the step (b) or the repetition step reaches a predetermined time limit.

4. A method according to claim 1, wherein
the time divisor is the greatest common divisor of all the set-up work times in the job list.

5. A method according to claim 1, further comprising:
(d) explicitly stating whether the final solution of the work plan is an optimal solution or an approximate solution and outputting the final solution.

6. A method according to claim 1, wherein
the step (a) includes setting a value of the time divisor as the processing condition, the value being specified by a user.

7. A work plan creation device being configured to create a work plan in which a plurality of jobs are distributed to and executed by a plurality of machines, the work plan creation device comprising:
a processing condition setting unit configured to set a processing condition including a job list that defines set-up work times in the plurality of machines for each of the plurality of jobs; and
a computation unit configured to obtain a temporary solution for the work plan by dividing each of the set-up work times in the job list by a time divisor to create a simplified job list and solving a job shop scheduling problem relating to the simplified job list as a 0-1 integer programming problem, wherein
the computation unit modifies work times of respective jobs in the temporary solution of the set-up work times and obtains a final solution of the work plan.

8. A non-transitory computer-readable storage medium storing a computer program for causing a processor to execute processing of creating a work plan in which a plurality of jobs are distributed to and executed by a plurality of machines, the computer for causing the processor to execute processing of:
(a) setting a processing condition including a job list that defines set-up work times in the plurality of machines for each of the plurality of jobs;
(b) obtaining a temporary solution for the work plan by dividing each of the set-up work times in the job list by a time divisor to create a simplified job list and solving a job shop scheduling problem relating to the simplified job list as a 0-1 integer programming problem; and
(c) modifying work times of respective jobs in the temporary solution of the set-up work times and obtaining a final solution of the work plan.
